(19) United States
(12) Patent Application Publication
(10) Pub. No.: US 2026/0208129 A1
(43) Pub. Date: Jul. 23, 2026

(54) STATIC MIXER FOR FLUIDS

(71) Applicant: GE INFRASTRUCTURE TECHNOLOGY LLC, Greenville, SC (US)

(72) Inventors: Sandeep Kumar Reddy VENKATA, Karnataka (IN); Surendra MISHRA, Karnataka (IN)

(21) Appl. No.: 19/140,823

(22) PCT Filed: Dec. 18, 2023
(86) PCT No.: PCT/US2023/084584

§ 371 Date: Jun. 18, 2025

(30) Foreign Application Priority Data
Dec. 23, 2022 (IN) 202211075045

(51) Int. Cl. B01F 25/313; B01F 23/10; B01F 25/433; B01F 25/452; B01F 101/00

(52) U.S. Cl. CPC B01F 25/3131; B01F 23/10; B01F 25/3133; B01F 25/4336; B01F 25/4521; B01F 2101/501; B01F 2215/0422; B01F 2215/0431

(57) ABSTRACT

A static mixer includes a hollow body having defined therein a first and a second fluid inlet port and a fluid outlet. A mixing structure is positioned between both the first and second fluid inlet ports and the fluid outlet. The mixing structure includes a restrictor structure in the hollow body having a cross-axis area that is smaller than a cross-axis area of the hollow body, a diverter having a diverging surface and positioned downstream of the restrictor structure, and a support coupled to the diverter and the hollow body to align the diverter with the centerline axis of the hollow body. The first fluid inlet port introduces a first fluid, e.g., natural gas, along the centerline axis, and the second fluid inlet port introduces a second fluid, e.g., hydrogen, along the centerline axis upstream of the restrictor structure.

### TECHNICAL FIELD

The disclosure relates generally to fluid mixers and, more particularly, to a static mixer for two or more fluids supplied to a combustor of a gas turbine engine.

### BACKGROUND

Static mixers are structures that mix fluids, such as gases or liquids, together with no moving parts. Current static mixers for fluids, such as fuel gases, are complex and costly structures.

### BRIEF DESCRIPTION

All aspects, examples and features mentioned below can be combined in any technically possible way.

An aspect of the disclosure provides a static mixer, comprising: a hollow body having defined therein: a first fluid inlet port for introducing a first fluid along a centerline axis of the hollow body; a second fluid inlet port for introducing a second fluid along the centerline axis of the hollow body downstream of the first fluid inlet port; and a fluid outlet downstream of the first and second fluid inlet ports; and a first mixing structure positioned between both the first and second fluid inlet ports and the fluid outlet, the first mixing structure including: a first restrictor structure in the hollow body, the first restrictor structure having a cross-axis area that is smaller than a cross-axis area of the hollow body; a first diverter having an at least frustoconical shape and positioned downstream of the first restrictor structure; and a first support coupled to the first diverter and the hollow body to align the first diverter with the centerline axis of the hollow body; and wherein the second fluid inlet port introduces the second fluid along the centerline axis upstream of the first restrictor structure.

Another aspect of the disclosure includes any of the preceding aspects, and the first diverter has an upstream end and a downstream end, the upstream end smaller than the downstream end.

Another aspect of the disclosure includes any of the preceding aspects, and the upstream end of the first diverter consumes between 0.5% to 10% of the cross-axis area of the hollow body, and the downstream end of the first diverter consumes between 20% to 70% of the cross-axis area of the hollow body.

Another aspect of the disclosure includes any of the preceding aspects, and the first diverter has a conical shape.

Another aspect of the disclosure includes any of the preceding aspects, and the first diverter includes a wall extending at an angle with the centerline axis of the hollow body in a range of between 10° and 50°.

Another aspect of the disclosure includes any of the preceding aspects, and the hollow body has a circular interior and an inner diameter, and wherein the first diverter has a length between 0.4 to 1.5 times the diameter of the hollow body.

Another aspect of the disclosure includes any of the preceding aspects, and the first restrictor structure consumes between 30% to 70% of the cross-axis area of the hollow body.

Another aspect of the disclosure includes any of the preceding aspects, and the first restrictor structure includes an annular ring extending inwardly from an interior surface of the hollow body.

Another aspect of the disclosure includes any of the preceding aspects, and the first restrictor structure includes a plate member having a plurality of openings therein, the plate member extending cross-axially within the hollow body.

Another aspect of the disclosure includes any of the preceding aspects, and further comprising a second restrictor structure having a cross-axis area that is smaller than the cross-axis area of the hollow body, the second restrictor structure positioned downstream of the first diverter.

Another aspect of the disclosure includes any of the preceding aspects, and the hollow body has a circular interior and an inner diameter, and wherein the second restrictor structure is positioned downstream of the first diverter a distance between 0.4 to 1.2 times the diameter of the hollow body.

Another aspect of the disclosure includes any of the preceding aspects, and the first support includes a plurality of structural members coupled to a wall of the first diverter and to an interior surface of the hollow body.

Another aspect of the disclosure includes any of the preceding aspects, and the plurality of structural members extend through the first diverter and meet at the centerline axis of the hollow body.

Another aspect of the disclosure includes any of the preceding aspects, and the first fluid includes natural gas, and the second fluid includes hydrogen; and wherein the static mixer is upstream of a combustor of a gas turbine engine.

Another aspect of the disclosure includes any of the preceding aspects, and further comprising a second mixing structure configured to be positioned downstream of the first mixing structure in the hollow body, the second mixing structure including: a second restrictor structure having a cross-axis area that is smaller than the cross-axis area of the hollow body; a second diverter having an at least frustoconical shape positioned downstream of the second restrictor structure; and a second support positioning the at least frustoconical diverter aligned with the centerline axis of the hollow body.

Another aspect of the disclosure relates to a static mixer, comprising: a hollow body having defined therein a first fluid inlet port, a second fluid inlet port and a fluid outlet downstream of the first and second fluid inlet ports, wherein the hollow body has a centerline axis; and a mixing structure positioned between both the first and second fluid inlet ports and the fluid outlet, the mixing structure including: a restrictor structure in the hollow body, the restrictor structure having a cross-axis area that is smaller than a cross-axis area of the hollow body; a diverter having a diverging surface and positioned downstream of the restrictor structure; and a support coupled to the diverter and the hollow body to align the diverter with the centerline axis of the hollow body; and wherein the first fluid inlet port introduces a first fluid along the centerline axis and the second fluid inlet port introduces a second fluid along the centerline axis upstream of the restrictor structure.

Another aspect of the disclosure includes any of the preceding aspects, and the diverter has an at least frustoconical shape having an upstream end and a downstream end, the upstream end smaller than the downstream end.

Another aspect of the disclosure includes any of the preceding aspects, and the diverter has a conical shape.

Another aspect of the disclosure includes any of the preceding aspects, and the restrictor structure includes an annular ring extending inwardly from an interior surface of the hollow body.

Another aspect of the disclosure includes any of the preceding aspects, and the support includes a plurality of structural members coupled to a wall of the diverter and to an interior surface of the hollow body.

Two or more aspects described in this disclosure, including those described in this summary section, may be combined to form implementations not specifically described herein.

The details of one or more implementations are set forth in the accompanying drawings and the description below. Other features, objects and advantages will be apparent from the description and drawings, and from the claims.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a cross-sectional view of a static mixer, according to embodiments of the disclosure;

FIG. 2 shows a perspective view of a mixing structure of the static mixer, according to embodiments of the disclosure;

FIG. 3 shows a cross-sectional view of a mixing structure of the static mixer, according to embodiments of the disclosure;

FIG. 4 shows a perspective view of a mixing structure of the static mixer, according to other embodiments of the disclosure;

FIG. 5 shows a cross-sectional view of a mixing structure of the static mixer, according to yet other embodiments of the disclosure;

FIG. 6 shows a cross-sectional view of a mixing structure of the static mixer, according to additional embodiments of the disclosure;

FIG. 7 shows a cross-sectional view of a static mixer, according to other embodiments of the disclosure;

FIG. 8 shows a cross-sectional view of a series of static mixers, according to yet other embodiments of the disclosure; and

FIG. 9 shows a schematic view of a gas turbine system in which a static mixer according to embodiments of the disclosure can be employed.

It is noted that the drawings of the disclosure are not necessarily to scale. The drawings are intended to depict only typical aspects of the disclosure and therefore should not be considered as limiting the scope of the disclosure. In the drawings, like numbering represents like elements between the drawings.

### DETAILED DESCRIPTION

As an initial matter, in order to clearly describe the current disclosure, it will become necessary to select certain terminology when referring to and describing relevant machine components within the illustrative application of a static mixer. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

In addition, several descriptive terms may be used regularly herein, and it should prove helpful to define these terms at the onset of this section. These terms and their definitions, unless stated otherwise, are as follows. As used herein, “downstream” and “upstream” are terms that indicate a direction relative to the flow of a fluid, such as a fluid to be mixed by a static mixer. The term “downstream” corresponds to the direction of flow of the fluid, and the term “upstream” refers to the direction opposite to the flow.

It is often required to describe parts that are at different radial positions with regard to a center axis. The term “axial” refers to movement or position parallel to an axis, e.g., a centerline axis of a part of a static mixer. The term “radial” refers to movement or position perpendicular to an axis. In cases such as this, if a first component resides closer to the axis than a second component, it will be stated herein that the first component is “radially inward” or “inboard” of the second component. If, on the other hand, the first component resides further from the axis than the second component, it may be stated herein that the first component is “radially outward” or “outboard” of the second component. Finally, the term “circumferential” refers to movement or position around a centerline axis, e.g., a circumferential interior surface of a circular hollow body of a static mixer. As will be described further herein, such terms may be applied in relation to a centerline axis of a hollow body of a static mixer.

In addition, several descriptive terms may be used regularly herein, as described below. The terms “first,” “second,” and “third,” may be used interchangeably to distinguish one component from another and are not intended to signify location or importance of the individual components.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event may or may not occur or that the subsequently described feature may or may not be present and that the description includes instances where the event occur or the feature is present and instances where the event does not occur or the feature is not present.

Where an element or layer is referred to as being “on,” “engaged to,” “connected to,” “coupled to,” or “mounted to” another element or layer, it may be directly on, engaged, connected, coupled, or mounted to the other element or layer, or intervening elements or layers may be present. In contrast, when an element is referred to as being “directly on,” “directly engaged to,” “directly connected to,” or “directly coupled to” another element or layer, there are no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. The verb forms of “couple” and “mount” may be used interchangeably herein.

As indicated above, the disclosure provides a static mixer for a number of fluids. The static mixer includes a hollow body having defined therein a first and second fluid inlet port and a fluid outlet. A mixing structure is positioned between both the first and second fluid inlet ports and the fluid outlet. The mixing structure includes a restrictor structure in the hollow body having a cross-axis area that is smaller than a cross-axis area of the hollow body, a diverter having a diverging surface and positioned downstream of the restrictor structure, and a support coupled to the diverter and the hollow body to align the diverter with the centerline axis of the hollow body. The first fluid inlet port introduces a first fluid, e.g., natural gas, along the centerline axis and the second fluid inlet port introduces a second fluid, e.g., hydrogen, along the centerline axis upstream of the diverter. The static mixer presents a simple, compact, and low-cost mechanism to mix two fluids. The static mixer may include more than one mixing structure, and multiple static mixers may be used in series to mix more than two fluids.

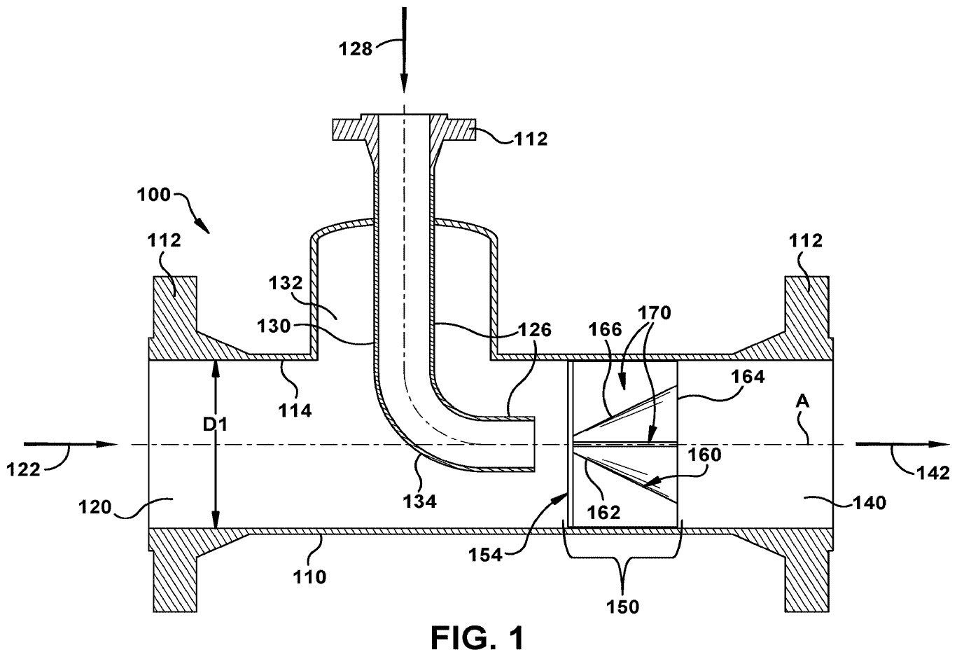

FIG. 1 shows a cross-sectional view of a static mixer 100 according to embodiments of the disclosure. Static mixer 100 (hereafter “mixer 100”) does not include any moving parts. Mixer 100 may include a hollow body 110. Hollow body 110 may have any cross-sectional shape, but for purposes of description is shown as a circular hollow body. In this illustrative case, hollow body 110 has a circular interior surface 114 and an illustrative inner diameter D1. While shown as having a uniform diameter and thus a uniform cross-axis (or cross-sectional) area (e.g., where circular A=πr²), hollow body 110 may have a varying cross-axis area along its length.

Hollow body 110 includes a first fluid inlet port 120 for introducing a first fluid 122 along a centerline axis A of hollow body 110. Hollow body 110 also includes a second fluid inlet port 126 for introducing a second fluid 128 along centerline axis A of hollow body 110 downstream of first fluid inlet port 120. In the example shown, first fluid inlet port 120 includes an open end of hollow body 110; however, alternative options are possible. In the example shown, second fluid inlet port 126 includes a conduit 130 mounted through an opening 132 in a side of hollow body 110 and has a right angle 134 to direct second fluid 128 along centerline axis A downstream of first fluid inlet port 120. It will be recognized that first and second fluid inlet ports 120, 126 can take a variety of alternative forms. For example, second fluid inlet port 126 could include piping that enters hollow body 110 at any variety of angles, e.g., 30°, 45°, etc., so long as opening 132 directs second fluid 128 along centerline axis A. The perpendicular arrangement of opening 132 relative to hollow body 110 is thus simply illustrative.

Fluids 122, 128 can take any form. For purposes of description, fluids 122, 128 may include gaseous fuels that are combined to form a combined fluid mixture 142 of the gaseous fluids. In certain embodiments, first fluid 122 may include natural gas (i.e., mostly methane (CH₄) but other hydrocarbons also) and second fluid 128 may include hydrogen (H₂). Hence, fluid mixture 142 includes natural gas and hydrogen. The static mixer 100 can mix any industrial gas such as natural gas with varying composition of its constituents, syngas, liquid propane gas (LPG), hydrogen, hot air, and cold air, etc. Also, the static mixer 100 can be applied to mix miscible liquids such as but not limited to: ethylene glycol and water, or alcohol with water. Other fluids, including other gases or liquids, may also be mixed using the static mixer 100.

While second fluid inlet port 126 (introducing, e.g., hydrogen) is shown having a smaller cross-sectional area than first fluid inlet port 120 (introducing, e.g., natural gas), they may be any size depending on, for example, the fluid carried therein, the desired volume of each fluid in fluid mixture 142, and/or characteristics of the fluid therein including but not limited to: density, temperature, composition, flow rate and/or entry pressure.

Hollow body 110 also includes a fluid outlet 140 downstream of first and second fluid inlet ports 120, 126 through which a fluid mixture 142 of first and second fluids 122, 128 passes after being mixed. Fluid outlet 140 may couple to any variety of piping structures for delivery of fluid mixture 142 to a desired application.

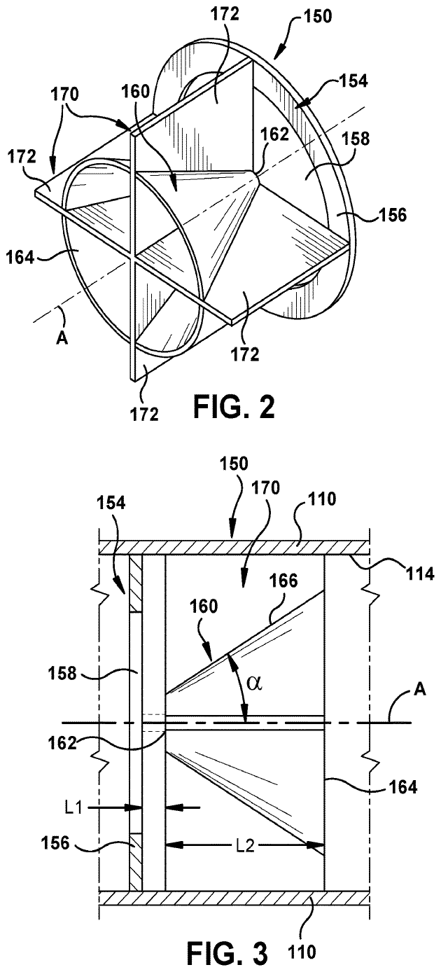

Mixer 100 also includes a mixing structure 150 positioned between first and second fluid inlet ports 120, 126 and fluid outlet 140. FIG. 2 shows a perspective view (looking upstream), and FIG. 3 shows a cross-sectional view of mixing structure 150 according to certain embodiments of the disclosure. As will be described, mixing structure 150 mixes first and second fluids 122, 128 to form fluid mixture 142. Mixing structure 150 may include a restrictor structure 154 in hollow body 110. Restrictor structure 154 has a cross-axis area that is smaller than a cross-axis area of hollow body 110, i.e., where restrictor structure 154 is located in hollow body 110. Restrictor structure 154 thus forces first fluid 122 and second fluid 128 radially inwardly toward centerline axis A of hollow body 110 as the fluids encounter the structure. Restrictor structure 154 may take a variety of forms. In one embodiment, shown for example in FIG. 2, restrictor structure 154 includes an annular ring 156 extending inwardly, e.g., from interior surface 114 of hollow body 110. Annular ring 156 may be planar and have an opening 158 therein having a smaller cross-axis area than hollow body 110 where restrictor structure 150 is located.

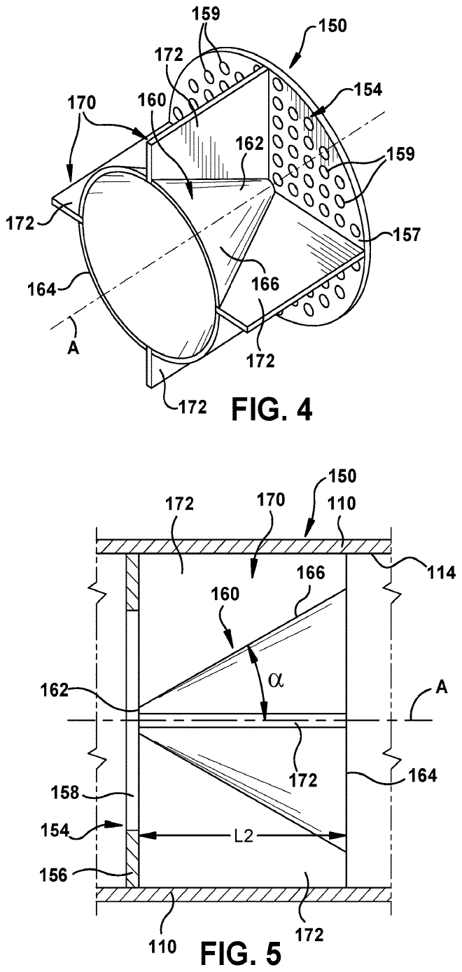

FIG. 4 shows a perspective view (looking upstream) of mixing structure 150 according to other embodiments of the disclosure. In this embodiment, restrictor structure 154 includes a plate member 157 having a plurality of openings 159 therein. While openings 159 are shown as circular, they can have any shape, e.g., oval, polygonal, etc. Plate member 157 extends cross-axially within hollow body 110. Regardless of form, in one embodiment, restrictor structure 150 may consume between approximately 30% to approximately 70% of the cross-axis area of hollow body 110. That is, annular ring 154 or plate member 157 excepting the collective area of openings 159, consumes approximately 30% to approximately 70% of the cross-axis area of hollow body 110. In another embodiment, restrictor structure 150 may consume approximately 40% of the cross-axis area of hollow body 110. As used herein, “consumes” as it applies to cross-axis area indicates a blocking of flow through that cross-axis area by that percentage of the total cross-axis area of hollow body 110 at the location of the particular structure referenced.

Restrictor structure 150 may be located anywhere upstream of a diverter 160 of mixing structure 150. In FIG. 1, restrictor structure 150 may contact an upstream end 162 of diverter 160 so it can be supported by diverter 160 without additional support therefor, and/or it can help support diverter 160. In contrast, in FIG. 3, restrictor structure 150 is spaced from an upstream end 162 of diverter 160, e.g., by a distance L1. The distance L1 from diverter 160 and the cross-axis area consumed by restrictor structure 154 may be customized to provide any desired mixing characteristics depending on physical characteristics of fluids 122, 128 including but not limited to: the volume of each fluid in fluid mixture 142, and/or characteristics of the fluid therein including but not limited to: density, temperature, composition, flow rate and/or pressure.

Mixing structure 150 also includes diverter 160. Diverter 160 is positioned downstream of restrictor structure 150. Second fluid inlet port 126 introduces second fluid 128 along centerline axis A upstream of diverter 160 (and restrictor structure 150). Diverter 160 has upstream end 162 and a downstream end 164. Upstream end 162 is smaller in size (e.g., measured by cross-axis area) than downstream end 164 such that diverter 160 has a diverging surface 166. Diverging surface 166 can have a variety of shapes. In certain embodiments, diverter 160 (i.e., diverging surface 166) has an at least frustoconical shape. As used herein, “at least frustoconical shape” means diverter 160 has its upstream end 162 that cuts across the otherwise conical shape to form a frustum of a cone but the shape can also extend to be a fully conical shape. FIGS. 1-3 show diverters 160 with diverging surfaces 166 having frustoconical shapes. In contrast, FIG. 5 shows a cross-sectional view of a mixing structure 150 having a diverter 160 having a fully conical shape, i.e., upstream end 162 includes a pointed end. Diverging surface 166 can have other shapes also, e.g., a pyramid, octagonal pyramid, among others.

Regardless of shape, in certain embodiments, upstream end 162 of diverter 160 may consume between 0.5% to 10% of the cross-axis area of hollow body 110 where it is located, and downstream end 164 of diverter 160 may consume between approximately 20% to approximately 70% of the cross-axis area of hollow body 110 where it is located. In other embodiments, upstream end 162 of diverter 160 may consume between approximately 1% of the cross-axis area of hollow body 110 where it is located, and downstream end 164 of diverter 160 may consume approximately 50% of the cross-axis area of hollow body 110. In any event, diverter 160 directs fluids 122, 128 radially outwardly toward interior surface 114 and away from centerline axis A of hollow body 110, forcing the fluids 122, 128 to mix together to form mixture 142.

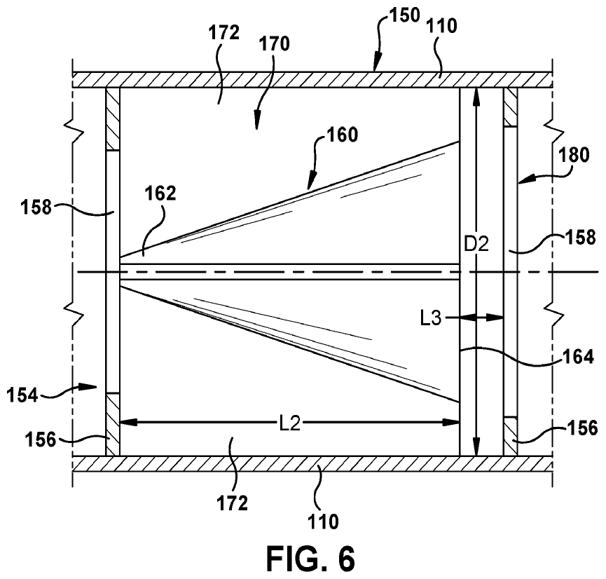

In other embodiments, diverter 160 includes a wall, i.e., diverging surface 166, extending at an angle α with centerline axis A of hollow body 110. In certain embodiments, angle α may be in a range of between 10° and 50°. In other embodiments, angle α may be approximately 30°. Diverter 160 may also have a length L2 configured to provide the desired mixing of fluids 122, 128. In certain embodiments, diverter 160 may have a length L2 between 0.4 to 1.5 times diameter D1 of hollow body 110, i.e., at the location where diverter 160 is located in hollow body 110. FIG. 6 shows a cross-sectional view of a mixing structure 150 having diverter 160 having a different length L2 compared to that shown in FIGS. 3 and 5. Any length L2 to generate the desired mixing is possible.

Any of the characteristics of diverter 160 (e.g., cross-axis area consumed by either end 162, 164; diverging surface 166 shape; angle α; and/or length L2, etc.) may be customized to provide any desired mixing characteristics depending on physical characteristics of fluids 122, 128 including but not limited to: volume of each fluid, density, temperature, flow rate and/or entry pressure.

Mixing structure 150 also includes a support 170 coupled to diverter 160 and hollow body 110, for example, to align first diverter 160 with centerline axis A of hollow body 110. Support 170 also provides strength and rigidity to diverter 160. Support 170 includes a plurality of structural members 172 coupled to the wall of diverter 160 (i.e., to or through diverging surface 166) of diverter 160 and to interior surface 114 of hollow body 110. In the example shown, structural members 172 may include plate members, but other structural members such as struts or other elongated, thinner members can be employed. In the example shown, four structural members 172 are used, but any number may be employed, i.e., 2, 3 or more than 4. In certain embodiments, shown for example in FIG. 2, plurality of structural members 172 extend through diverter 160 and meet at centerline axis A of hollow body 110. In this case, diverter 160 may be formed of a number of segments coupled to structural members 172, and all of the parts are fixed together. In other embodiments, shown for example in FIG. 4, where diverter 160 has self-sufficient strength and rigidity to not require internal support, plurality of structural members 172 may extend to diverging surface 166 of diverter 160 but not inside of diverter 160.

FIG. 6 also shows another alternative embodiment in which mixer 100 includes another restrictor structure 180 having a cross-axis area that is smaller than the cross-axis area of hollow body 110 where it is located. Restrictor structure 180 is positioned downstream of diverter 160. Restrictor structure 180 can have any of the physical arrangements previously described relative to restrictor structure 154. Restrictor structure 180 may be identical to restrictor structure 154, but more likely has a different configuration, e.g., it consumes a different cross-axis area to provide different mixing of fluids 122, 128 downstream of diverter 160. Any of the physical characteristics can be customized to generate the desired mixing.

Restrictor structure 180 may be positioned downstream of diverter 160 at any desired distance L3. In certain embodiments, restrictor structure 180 may be positioned downstream of diverter 160 at distance L3 between 0.4 to 1.2 times a diameter D2 of hollow body 110 where it is located. The distance L3 from diverter 160, i.e., downstream end 164, and the cross-axis area consumed by restrictor structure 180 may be customized to provide any desired mixing characteristics depending on physical characteristics of fluids 122, 128 including but not limited to: density, temperature, flow rate and/or entry pressure.

Referencing FIG. 1, in operation, first fluid inlet port 120 introduces first fluid 122 and directs it along centerline axis A of hollow body 110 toward mixing structure 150, and second fluid inlet port 126 introduces second fluid 128 and directs it along centerline axis A of hollow body 110 toward mixing structure 150 downstream of first fluid inlet port 120. Fluids 122, 128 are directed radially inward from interior surface 114 as they meet restrictor structure 154 and flow towards upstream end 162 of diverter 160, starting the mixing of the fluids. Fluids 122, 128 are then directed radially outwardly toward interior surface 114 of hollow body by diverter 160, continuing the mixing. Continued mixing occurs as fluids 122, 128 pass downstream end 164 of diverter 160 and enter the full cross-axis area of hollow body 110. Further mixing occurs immediately downstream of diverter 160 due to the disturbances induced by mixing structure 150, and, where provided, second restrictor structure 180 may direct the fluids radially inward from interior surface 114 as they meet restrictor structure 180. Fluid mixture 142 then exits mixer 100 via fluid outlet 142.

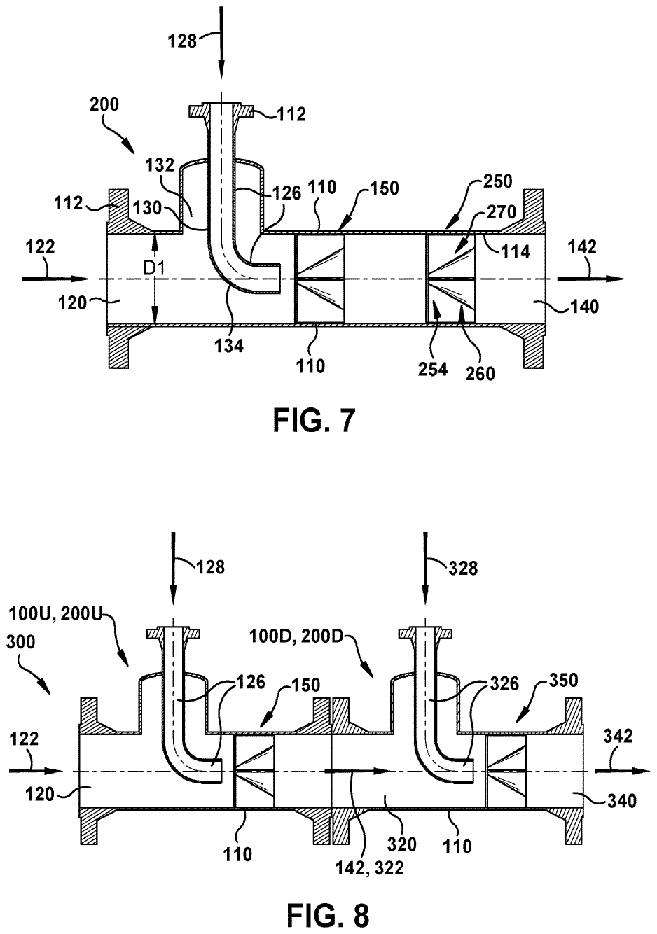

FIG. 7 shows a cross-sectional view of a static mixer 200 according to other embodiments of the disclosure. Static mixer 200 includes the same structure as static mixer 100 described previously, but also includes another, second mixing structure 250 configured to be positioned downstream of first mixing structure 150 in hollow body 110. That is, two mixing structures 150, 250 are in the same hollow body 110 and are axially separated from one another. Second mixing structure 250 may generally include the same subcomponents as mixing structure 150. For example, second mixing structure 250 may include a second restrictor structure 254 having a cross-axis area that is smaller than the cross-axis area of hollow body 110 where it is located. Second mixing structure 250 may also include a second diverter 260 having an at least frustoconical shape positioned downstream of second restrictor structure 254. Second mixing structure 250 may also include a second support 270 positioning the at least frustoconical diverter 260 in alignment with centerline axis A of hollow body 110. Second mixing structure 250 can also include a second restrictor structure (not shown) downstream of its diverter 260. Second mixing structure 250 may have identical physical characteristics as mixing structure 150, but more likely is not identical so as to provide different mixing characteristics to fluids 122, 128 compared to mixing structure 150.

FIG. 8 shows a cross-sectional view of a static mixer 300 according to other embodiments of the disclosure. A static mixer 300 includes two or more static mixers 100, 200, as described herein, arranged in series to allow mixing of three or more fluids 122, 128 and 328. While FIG. 8 shows mixer 300 including a number of mixers 100 (e.g., as in FIG. 1), it will be readily recognized by those with skill in the art that a number of mixers 200 (e.g., as in FIG. 7) can also be employed in a series fashion. Any number of mixers 100, 200 can be used in series to mix any number of fluids. In the FIG. 8 example, (first) fluid mixture 142 exiting an upstream mixer 100U, 200U (left side) enters a downstream mixer 100D, 200D (right side) as its first fluid 322, and a third fluid 328 is introduced by a third fluid inlet port 326 along centerline axis A upstream of mixing structure 350 of downstream mixer 100D, 200D. Third fluid 328 is mixed with the (first) fluid mixture 322, including first fluid 122 and second fluid 128, to form a new fluid mixture 342. In this manner, any number of fluids can be serially mixed to form a fluid mixture according to the teachings of the disclosure. While shown as two coupled hollow bodies 110 in FIG. 8, a single hollow body 110 including two or more fluid inlet ports 126, 326 may be used instead. The serially arranged mixers can be identical, or one or more the mixers can be physically customized, as described herein, to provide the desired mixing characteristics of the previous mixer's fluid mixture and the particular new fluid to be added to the previous mixer's fluid mixture.

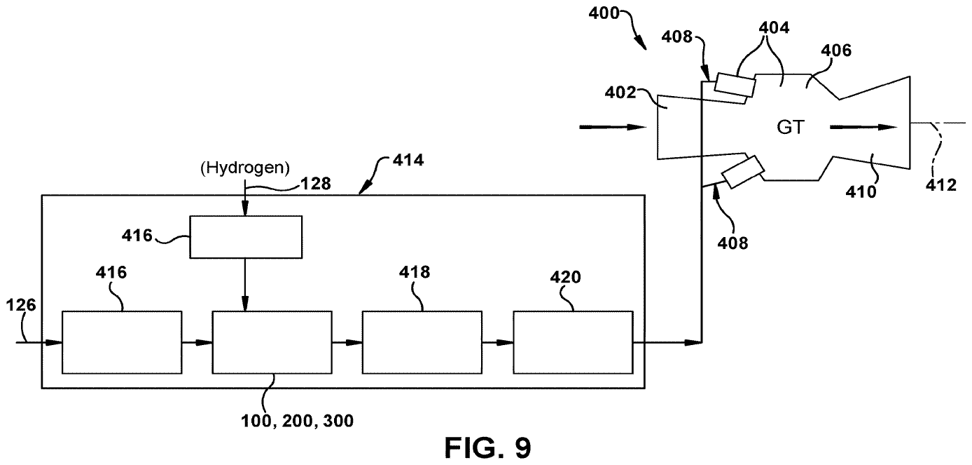

FIG. 9 shows a schematic view of an illustrative application of mixers 100, 200, 300 in the form of a gas turbine (GT) system 400. GT system 400 includes a compressor 402 and a combustor 404. Combustor 404 includes a combustion region 406 and a fuel nozzle assembly 408. GT system 400 also includes a turbine 410 and a common compressor/turbine shaft 412 (sometimes referred to as a rotor 412). In one embodiment, GT system 400 is a 7HA.03 engine, commercially available from General Electric Company, Greenville, S.C. The present disclosure is not limited to any one particular GT system and may be implanted in connection with other engines including, for example, the other HA, F, B, LM, GT, TM and E-class engine models of General Electric Company, and engine models of other companies. The present disclosure is not limited to any particular turbine or turbomachine, and may be applicable to, for example, steam turbines, jet engines, compressors, turbofans, etc.

In operation, air flows through compressor 402, and compressed air is supplied to combustor 404. Specifically, the compressed air is supplied to fuel nozzle assembly 408 that is integral to combustor 404. Assembly 408 is in flow communication with combustion region 406. Fuel nozzle assembly 408 is also in flow communication with a fuel source 414 and channels fuel and air to combustion region 406. Fuel source 414 may include a fuel gas conditioner 416 for each fluid 126, 128 upstream and a combined fuel gas conditioner 418 downstream of mixer 100, 200, 300, according to embodiments of the disclosure. Conditioners 416, 418 may include any now known or later developed fluid conditioning equipment appropriate for the fuel. Fuel source 414 may also include any now known or later developed control valve system 420. Combustor 404 ignites and combusts fuel (i.e., fluid mixture 142, 342) delivered by control valve system 420. Combustor 404 is in flow communication with turbine assembly 410 for which gas stream thermal energy is converted to mechanical rotational energy. Turbine assembly 410 includes a turbine that rotatably couples to and drives rotor 412. Compressor 402 also is rotatably coupled to rotor 412. In the illustrative embodiment, there are a plurality of combustors 404 and fuel nozzle assemblies 408.

In the non-limiting example of GT system 400 using hydrogen and natural gas, the natural gas may have a flow rate in a range of approximately 8 to 23 kilograms/second (kg/s) (18-50 pounds/second (lb/s)), a temperature in a range of approximately 10 to 315° C. (50-600° F.) and a pressure of approximately 2 to 4.1 MegaPascals (MPa) (300-600 pound/square inch (psi)), and the hydrogen may have a flow rate in a range of approximately 0.05 to 2.0 kg/s (0.12-4.5 lb/s), a temperature in a range of approximately 10 to 93° C. (50 -200° F.), and a pressure that is approximately 0.2 MPa (30 psi) above that of the natural gas, i.e., approximately 2.2 to 4.3 MPa (330-630 psi). Different GT systems may use fuel fluids at different conditions.

Mixers 100, 200, 300 including hollow body 110 and mixing structure(s) 150, 250, 350 may be made of any material capable of withstanding environmental conditions of the fluids that pass therethrough. In certain embodiments, hollow body 110 may be made of a metal or metal alloy such as steel or aluminum. In certain embodiments, hollow body 110 may be made of stainless steel ASTM, A276or TP 316/316L. Parts of mixer 100, 200, 300 may be formed separately and then combined together, e.g., using welding or other fixing processes, or mixer 100, 200, 300 may be formed as an integral part, e.g., using additive manufacturing. Hollow body 110 may include any variety of mounts 112 capable of coupling it to other fluid delivery elements, e.g., fluid delivery piping.

Embodiments of the disclosure provide various technical and commercial advantages, examples of which are discussed herein. For example, the static mixer presents a simple, compact and low-cost mechanism to mix two fluids. The static mixers may include more than one mixing structure and may be used in series to mix more than two fluids. The static mixer can be applied to any industrial gases such as natural gas with varying composition of its constituents, syngas, liquid propane gas (LPG), hydrogen, hot air, and cold air, etc. Also, the static mixer can be applied to mix liquids, for example, ethylene glycol and water, alcohol with water, etc.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise. “Approximately” or “about,” as applied to a particular value of a range, applies to both end values and, unless otherwise dependent on the precision of the instrument measuring the value, may indicate +/−5% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiments were chosen and described in order to best explain the principles of the disclosure and the practical application and to enable others of ordinary skill in the art to understand the disclosure such that various modifications as are suited to a particular use may be contemplated.

1. A static mixer, comprising:
a hollow body having defined therein:
a first fluid inlet port for introducing a first fluid along a centerline axis of the hollow body;
a second fluid inlet port for introducing a second fluid along the centerline axis of the hollow body downstream of the first fluid inlet port; and
a fluid outlet downstream of the first and second fluid inlet ports; and
a first mixing structure positioned between both the first and second fluid inlet ports and the fluid outlet, the first mixing structure including:
a first restrictor structure in the hollow body, the first restrictor structure having a cross-axis area that is smaller than a cross-axis area of the hollow body;
a first diverter having an at least frustoconical shape and positioned downstream of the first restrictor structure; and
a first support coupled to the first diverter and the hollow body to align the first diverter with the centerline axis of the hollow body wherein the first support includes a plurality of structural members coupled to a wall of the first diverter and to an interior surface of the hollow body; and
wherein the second fluid inlet port introduces the second fluid along the centerline axis upstream of the first restrictor structure.

2. The static mixer of claim 1, wherein the first diverter has an upstream end and a downstream end, the upstream end smaller than the downstream end.

3. The static mixer of claim 2, wherein the upstream end of the first diverter consumes between 0.5% to 10% of the cross-axis area of the hollow body, and the downstream end of the first diverter consumes between 20% to 70% of the cross-axis area of the hollow body.

4. The static mixer of claim 1, wherein the first diverter has a conical shape.

5. The static mixer of claim 1, wherein the first diverter includes a wall extending at an angle with the centerline axis of the hollow body in a range of between 10° and 50°.

6. The static mixer of claim 1, wherein the hollow body has a circular interior and an inner diameter, and wherein the first diverter has a length between 0.4 to 1.5 times the diameter of the hollow body.

7. The static mixer of claim 1, wherein the first restrictor structure consumes between 30% to 70% of the cross-axis area of the hollow body.

8. The static mixer of claim 1, wherein the first restrictor structure includes an annular ring extending inwardly from an interior surface of the hollow body.

9. The static mixer of claim 1, wherein the first restrictor structure includes a plate member having a plurality of openings therein, the plate member extending cross-axially within the hollow body.

10. The static mixer of claim 1, further comprising a second restrictor structure having a cross-axis area that is smaller than the cross-axis area of the hollow body, the second restrictor structure positioned downstream of the first diverter.

11. The static mixer of claim 10, wherein the hollow body has a circular interior and an inner diameter, and wherein the second restrictor structure is positioned downstream of the first diverter a distance between 0.4 to 1.2 times the diameter of the hollow body.

12. The static mixer of claim 1, wherein at least a portion of each structural member of the plurality of structural members extends from an exterior diverging surface of the wall of the first diverter to the interior surface of the hollow body.

13. The static mixer of claim 1, wherein the plurality of structural members extend through the first diverter and meet at the centerline axis of the hollow body.

14. The static mixer of claim 1, wherein the first fluid includes natural gas, and the second fluid includes hydrogen; and wherein the static mixer is upstream of a combustor of a gas turbine engine.

15. The static mixer of claim 1, further comprising a second mixing structure configured to be positioned downstream of the first mixing structure in the hollow body, the second mixing structure including:
a second restrictor structure having a cross-axis area that is smaller than the cross-axis area of the hollow body;
a second diverter having an at least frustoconical shape positioned downstream of the second restrictor structure; and
a second support positioning the at least frustoconical diverter aligned with the centerline axis of the hollow body.

16. A static mixer, comprising:
a hollow body having defined therein a first fluid inlet port, a second fluid inlet port, and a fluid outlet downstream of the first and second fluid inlet ports, wherein the hollow body has a centerline axis; and
a mixing structure positioned between both the first and second fluid inlet ports and the fluid outlet, the mixing structure including:
a restrictor structure in the hollow body, the restrictor structure having a cross-axis area that is smaller than a cross-axis area of the hollow body;
a diverter having a diverging surface and positioned downstream of the restrictor structure; and
a support coupled to the diverter and the hollow body to align the diverter with the centerline axis of the hollow body, wherein the support in a plurality of structural members coupled to a wall of the diverter and to an interior surface of the hollow body; and
wherein the first fluid inlet port introduces a first fluid along the centerline axis and the second fluid inlet port introduces a second fluid along the centerline axis upstream of the restrictor structure.

17. The static mixer of claim 16, wherein the diverter has an at least frustoconical shape having an upstream end and a downstream end, the upstream end smaller than the downstream end.

18. The static mixer of claim 16, wherein the diverter has a conical shape.

19. The static mixer of claim 16, wherein the restrictor structure includes an annular ring extending inwardly from an interior surface of the hollow body.

20. The static mixer of claim 16, wherein at least a portion of each structural member of the plurality of structrual members extends from an exterior diverging surface of the wall of the diverter to the interior surface of the hollow body.
